(19) United States
(12) Patent Application Publication
(10) Pub. No.: US 2014/0098941 A1
(43) Pub. Date: Apr. 10, 2014

(54) SYSTEMS FOR TRANSPORTING X-RAY DETECTOR AND DETECTOR CONTROL DEVICE

(71) Applicant: GENERAL ELECTRIC COMPANY, Schenectady, NY (US)

(72) Inventors: Nicholas Ryan Konkle, Waukesha, WI (US); Scott William Petrick, Sussex, WI (US); Alan Dean Blomeyer, Milwaukee, WI (US); James Zhengshe Liu, Salt Lake City, UT (US)

(73) Assignee: General Electric Company, Schenectady, NY (US)

(21) Appl. No.: 13/648,062

(22) Filed: Oct. 9, 2012

(51) Int. Cl. G01T 1/16

(52) U.S. Cl. 378/189

(57) ABSTRACT

A system is provided. The system includes a portable digital X-ray detector and a portable detector control device configured to communicate with the digital X-ray detector. The system also includes a coupling mechanism configured to couple the portable digital X-ray detector to the portable digital X-ray detector to enable simultaneous transport of the digital X-ray detector and the detector control device. The coupling mechanism does not communicate with any component of an imaging system including the portable digital X-ray detector and portable detector control device.

### BACKGROUND

The subject matter disclosed herein relates to X-ray imaging systems and more particularly to systems for transporting components of the X-ray imaging systems.

The advent of digital X-ray detectors has brought enhanced workflow and high image quality to medical imaging. However, many of the earlier radiographic imaging systems employ conventional X-ray imaging using film as the X-ray detection media. In order to obtain images from these systems, the imaging medium must be transported and processed after each exposure, resulting in a time delay in obtaining the desired images. Digital radiography provides an alternative that allows the acquisition of image data and reconstructed images on the spot for quicker viewing and diagnosis, and allows for images to be readily stored and transmitted to consulting and referring physicians and specialists. However, the cost of replacing the earlier conventional radiographic imaging systems with digital radiographic imaging systems may be imposing to a hospital or tertiary care medical center. Hence, there is a need to retrofit the earlier radiographic imaging systems for digital radiography in a cost effective manner involving as few components of the systems as possible. However, transporting the separate components to retrofit the earlier radiographic imaging systems (e.g., digital X-ray detector) between different radiographic imaging systems may prove unwieldy and impede work flow and/or the efficient use of time.

### BRIEF DESCRIPTION

In accordance with a first embodiment, a system is provided. The system includes a portable digital X-ray detector and a portable detector control device configured to communicate with the digital X-ray detector. The system also includes a coupling mechanism configured to couple the portable digital X-ray detector to the portable digital X-ray detector control device to enable simultaneous transport of the digital X-ray detector and the detector control device. The coupling mechanism does not communicate with any component of an imaging system including the portable digital X-ray detector and portable detector control device.

In accordance with a second embodiment, a system is provided. The system includes a portable digital X-ray detector and a portable detector control device configured to communicate with the digital X-ray detector. The system also includes a transport device configured to hold both the portable digital X-ray detector and the portable detector control device. The transport device does not communicate with any component of an imaging system including the portable digital X-ray detector and the portable detector control device.

In accordance with a third embodiment, a system is provided. The system includes a device configured to secure both a portable digital X-ray detector and a portable detector control device. The device does not communicate with any component of an imaging system including the portable digital X-ray detector and the portable detector control device.

### BRIEF DESCRIPTION OF THE DRAWINGS

These and other features, aspects, and advantages of the present subject matter will become better understood when the following detailed description is read with reference to the accompanying drawings in which like characters represent like parts throughout the drawings, wherein:

FIG. 1 is a diagrammatical overview of the X-ray system, equipped in accordance with aspects of the present technique;

FIG. 2 is a perspective view of a portable detector and portable detector control device having a coupling mechanism (e.g., magnets or hook and loop fasteners) to couple the detector and detector control device together;

FIG. 3 is a side view of the portable detector and portable detector control device of FIG. 2 coupled together;

FIG. 4 is a perspective view of a portable detector and portable detector control device having a coupling mechanism (e.g., pouch/slot and tab) to couple the detector and detector control device together;

FIG. 5 is a side view of the portable detector and the portable detector control device of FIG. 4 coupled together;

FIG. 6 is a perspective view of a portable detector and portable detector control device having a coupling mechanism (e.g., pouch or slot) to couple the detector and detector control device together;

FIG. 7 is a side view of the portable detector and the portable detector control device of FIG. 6 coupled together;

FIG. 8 is a perspective view of a portable detector and portable detector control device having a coupling mechanism (e.g., clasp) to couple the detector and detector control device together;

FIG. 9 is a side view of the portable detector and the portable detector control device of FIG. 8 coupled together;

FIG. 10 is a side cross-sectional view of an embodiment of a removable handle coupled to the detector of FIGS. 3-9;

FIG. 11 is perspective view of a portable detector, portable detector control device, and a device (e.g., snap fit caddy) for securing the detector and detector control device;

FIG. 12 is a side view of the portable detector and the portable detector control device of FIG. 11 secured within the device;

FIG. 13 is a perspective view of a portable detector, portable detector control device, and a device (e.g., folio caddy) for securing the detector and the detector control device;

FIG. 14 is a perspective view of a portable detector, portable detector control device, and a device (e.g., cart with wheels and extensions) for securing the detector and the detector control device;

FIG. 15 is another perspective view of the portable detector, portable detector control device, and the device of FIG. 14;

FIG. 16 is side view of a portable detector, portable detector control device, and a device (e.g., cart with wheels); and

FIG. 17 is a side view of a portable detector, portable detector control device, and a device (e.g., foldable cart).

### DETAILED DESCRIPTION

The present disclosure provides a device for transporting X-ray system components used to upgrade a conventional analog imaging system to a digital imaging system. These components include a portable digital X-ray detector and a portable detector control device. Such a transporting device enables the simultaneous transport of these components between different imaging systems. In particular, the device may secure the detector control device and detector to itself. For example, the device may be a transport device that holds both the detector control device and detector. Also, the device may include a coupling mechanism that couples the detector control device and the detector together. The device does not operatively function with other components of the imaging system such as a source controller, the detector, or the detector control device. Thus, the device does participate in image acquisition and image processing. Also, the device may not be required to communicate with components of the imaging system such as the detector and the detector control device, but may offer the ability to charge the battery of the detector or control device. The device is not coupled to nor includes an X-ray source. Instead, the device functions mainly in the transport of the detector and the detector control device. In certain embodiment, the device may include a charger to charge the detector or control device or one or more batteries for the detector or control device.

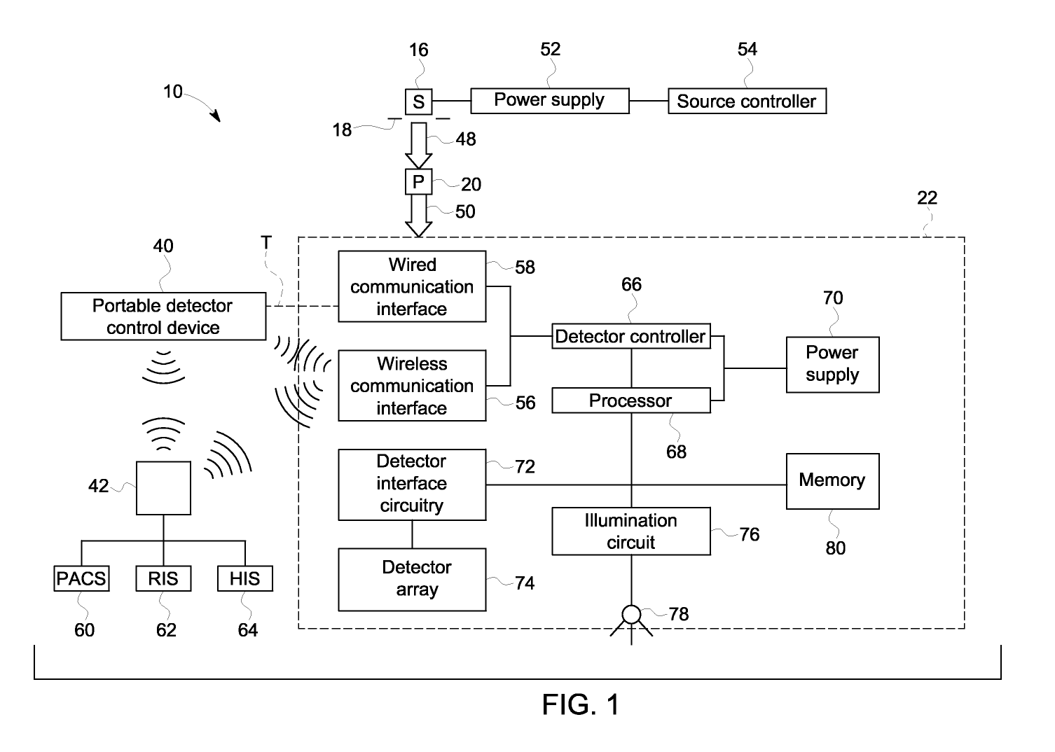

Referring generally to FIG. 1, an X-ray system is represented, referenced generally by reference numeral 10. In the illustrated embodiment, the X-ray system 10, as adapted, is a digital X-ray system. The X-ray system 10 is designed both to acquire image data and to process the image data for display. Throughout the following discussion, however, while basic and background information is provided on the digital X-ray system used in medical diagnostic applications, it should be born in mind that aspects of the present techniques may be applied to digital detectors, including X-ray detectors, used in different settings (e.g., projection X-ray, computed tomography imaging, tomosynthesis imaging, etc.) and for different purposes (e.g., parcel, baggage, vehicle and part inspection, etc.). The X-ray system 10 may include a conventional analog imaging system (e.g., stationary system disposed in a fixed X-ray imaging room or mobile imaging system), retrofitted for digital image data acquisition and processing as described below.

The imaging system 10 includes an X-ray radiation source 16 positioned adjacent to a collimator 18. Collimator 18 permits a stream of radiation 48 to pass into a region in which a subject 20, such as a human patient 20, is positioned. A portion of the radiation 50 passes through or around the subject 20 and impacts a detector 22. The detector 22 includes a portable digital X-ray detector. As described more fully below, detector 22 converts the X-ray photons received on its surface to lower energy photons, and subsequently to electric signals which are acquired and processed to reconstruct an image of the features within the subject 20.

The source 16 is coupled to a power supply 52 which furnishes power for examination sequences. The source 16 and power supply 52 are coupled to a source controller 54 configured to command X-ray emission of X-rays for image exposures. The detector 22 is configured to acquire X-ray image data without communication from the controller 54 of the X-ray radiation source 16. In other words, the detector 22 operates without communication of timing signals from the controller 54 of the source 16 as to an X-ray exposure. Thus, the detector 22 is without a priori knowledge of the beginning and ending times of an exposure. Also, the detector 22 is responsive to a portable detector control device 40 configured to communicate instructions the detector 22 for acquisition of the X-ray image data. In addition, the portable detector control device 40 is configured to receive the X-ray image data from the detector 22 for processing and imaging reconstruction.

The detector 22 includes a wireless communication interface 56 for wireless communication with the device 40, as well as a wired communication interface 58, for communicating with the device 40 when it is tethered to the detector 22. The detector 22 and/or the device 40 may also be in communication with the institution image review and storage system over the network 42 via a wired or wireless connection. The institution image review and storage system may include PACS 60, RIS 62, and HIS 64. In certain embodiments, the detector 22 may also communicate with components of the imaging system 10 such as the operator workstation via a wired or wireless connection. It is noted that the wireless communication interface 56 may utilize any suitable wireless communication protocol, such as an ultra wideband (UWB) communication standard, a Bluetooth communication standard, or any 802.11 communication standard. Moreover, detector 22 includes a detector controller 66 that coordinates the control of the various detector functions. For example, detector controller 66 may execute various signal processing and filtration functions, such as for initial adjustment of dynamic ranges, interleaving of digital image data, and so forth. The detector controller 66 is responsive to signals from the device 40. The detector controller 66 is linked to a processor 68. The processor 68, the detector controller 66, and all of the circuitry receive power from a power supply 70. The power supply 70 may include one or more batteries. Also, the processor 68 is linked to detector interface circuitry 72.

In one embodiment, the detector 22 converts X-ray photons received on its surface to lower energy photons such as light or optical photons (e.g., via a scintillator). The detector 22 includes a detector array 74 (e.g., imaging panel) that includes an array of photodetectors to convert the light photons to electrical signals. In certain embodiments, the detector array 74 also includes the scintillator. Alternatively, the detector 22 may convert the X-ray photons directly to electrical signals. These electrical signals are converted to digital values by the detector interface circuitry 72 which provides the values to the processor 68 to be converted to imaging data which may be used to reconstruct an image of the features within the subject 20. In one embodiment, the detector 22 may at least partially process or fully process the imaging data. Alternatively, the imaging data may be sent from the detector 22 to a server to process the imaging data.

The processor 68 is further linked to an illumination circuit 76. The detector controller 66, in response to a signal received from the device 40, may send a signal to the processor 68 to signal the illumination circuit 76 to illuminate a light 78 to indicate the detector 22 is prepared to receive an X-ray exposure in response to the signal. Indeed, in response to a signal from the device 40, the detector 22 may be turned on or awoken from an idle state. Alternatively, the detector 22 may be turned on directly or awoken from an idle state by the user (e.g., pressing an on/off button located on the detector 22).

Further, the processor is linked to a memory 80. The memory 80 may store various configuration parameters, calibration files, and detector identification data. In addition, the memory 80 may store patient information received from the device 40 to be combined with the image data to generate a DICOM compliant data file. Further, the memory 80 may store sampled data gathered during the imaging mode as well as X-ray images. As mentioned above, in some embodiments, the device 40 may conduct the image processing and incorporate a DICOM header to generate a DICOM compliant data file.

In other embodiments, the functions of the imaging system 10 may be decentralized, such that some functions of the imaging system 10 are performed at a workstation (e.g., controlling operation of the source 16), while other functions (e.g., controlling operation of the detector 22) are performed by another component of the X-ray system 10, such as the portable detector control device 40. The portable detector control device 40 may take the form of a personal digital assistant (PDA), palmtop computer, laptop computer, smart telephone, tablet computer, or any suitable general purpose or dedicated portable interface device. The portable detector control device 40 is configured to be held by a user and to communicate wirelessly with the detector 22. It is noted that the detector 22 and portable detector control device 40 may utilize any suitable wireless communication protocol, such as an IEEE 802.15.4 protocol, an ultra wideband (UWB) communication standard, a Bluetooth communication standard, or any IEEE 802.11 communication standard. Alternatively, the portable detector control device 40 may be configured to be tethered or detachably tethered to the detector 22 to communicate via a wired connection.

The portable detector control device 40 is also configured to communicate instructions (e.g., detector operating mode) to the detector 22 for the acquisition of X-ray image data. In turn, the detector 22 is configured to prepare for an X-ray exposure in response to instructions from the portable detector control device 40, and to transmit a detector ready signal to the device 40 indicating that the detector 22 is prepared to receive the X-ray exposure. The device 40 may also be configured to communicate patient information or X-ray technique information to the detector 22. Similar to the detector 22, the device 40 may operate without communication from the controller of the X-ray source 16. Further, the portable detector control device 40 is configured to receive X-ray image data from the detector 22 for processing and image reconstruction. Indeed, both the detector 22 and the portable detector control device 40 are configured to at least partially process the X-ray image data. However, in certain embodiments, the detector 22 and/or the portable detector control device 40 are configured to fully process the X-ray image data. Also, the detector 22 and/or the device 40 is configured to generate a DICOM compliant data file based upon the X-ray image data, patient information, and other information. Further, the detector 22 and/or the device 40 is configured to wirelessly transmit (or via a wired connection) processed X-ray image data (e.g., partially or fully processed X-ray image data) to an institution image review and storage system over a network 42. In some embodiments, the institution image review and storage system may process the X-ray image data. In one embodiment, the workstation may be configured to function as a server of instructions and/or content on a network 42 of the medical facility.

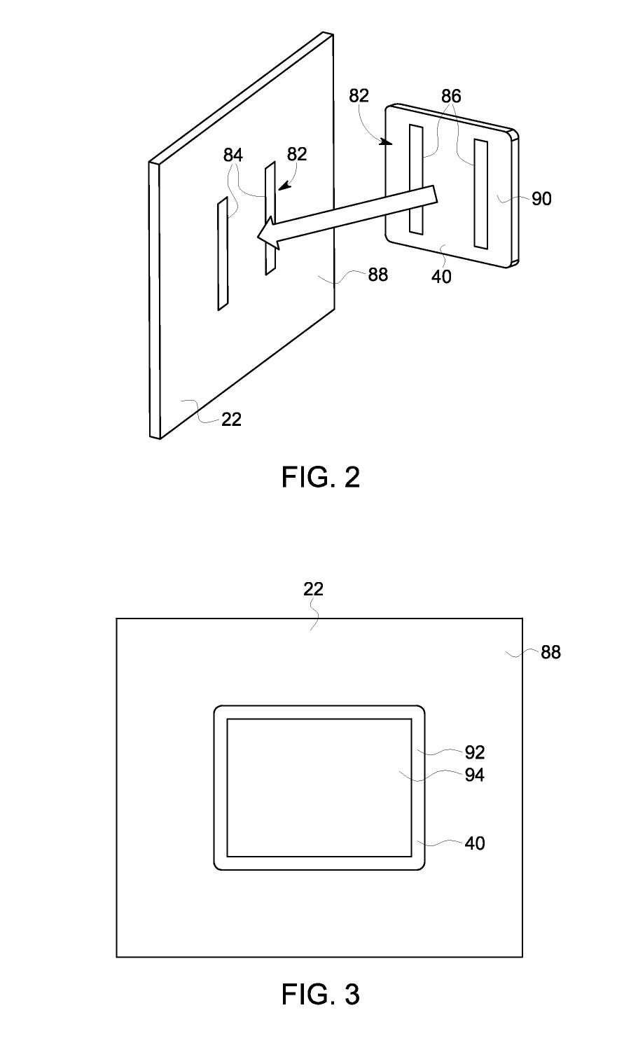

FIG. 2 discloses an embodiment of a device 82 (e.g., coupling mechanism) for coupling the detector 22 and the detector control device 40 together. The coupling mechanism 82 couples or holds together the detector 22 and detector control device 40 together to enable simultaneous transport of both. As depicted, both the detector 22 and the detector control device 40 include one or more attachment mechanisms (e.g., complementary structures) 84, 86 coupled to them respectively. The attachment mechanisms 84 are arranged in specific positions or a specific arrangement on or within the detector 22. The attachment mechanisms 86 are disposed in corresponding positions or in a corresponding arrangement on or within the detector control device 40 to interface with attachment mechanism 84 and to enable coupling of the detector 22 and the detector control device 40. The number, locations, or patterns of the attachment mechanisms 84, 86 may vary. In certain embodiments, the attachment mechanisms 84, 86 may include magnets disposed within the detector 22 and the detector control device 40. Alternatively, the magnets may be disposed on external surfaces 88, 90 of the detector 22 and the detector control device 40, respectively. As depicted, surface 90 is disposed opposite surface 92 that includes a screen 94. In certain embodiments, the attachment mechanisms 86 may be disposed on external surface 94 instead of surface 90. In other embodiments, the attachment mechanisms 84, 86 may include hook and loop fasteners disposed on the external surfaces 88, 90 of the detector 22 and the detector control device 40. For example, the attachment mechanisms 84 may include the hook portion of the hook and loop fasteners, while the attachment mechanisms 86 may include the loop portion of the hook and loop fasteners, or vice versa. Alternatively, the attachment mechanisms 84, 86 may include booth a hook portion and a loop portion. Upon aligning the attachment mechanisms 84, 86, the coupling mechanism 82 enables the coupling of the detector control device 40 to the detector 22 (e.g., with surfaces 88, 90 facing each other) as illustrated in FIG. 3.

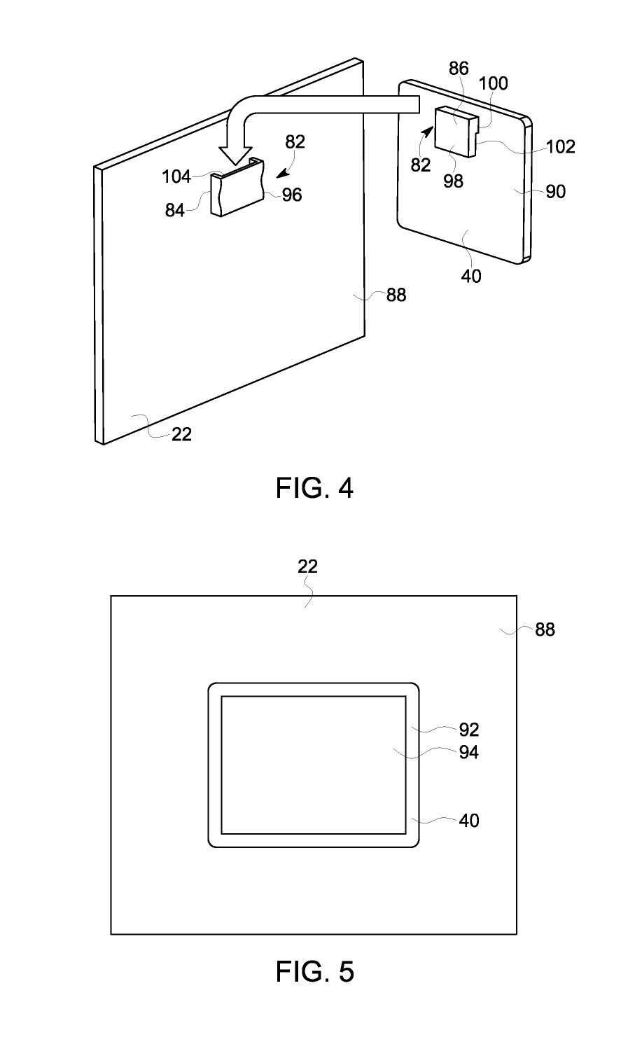

FIG. 4 discloses another embodiment of the device 82 (e.g., coupling mechanism) for coupling the detector 22 and the detector control device 40 together. As above, the coupling mechanism 82 couples or holds together the detector 22 and detector control device 40 together to enable simultaneous transport of both of them. As depicted, both the detector 22 and the detector control device 40 include attachment mechanisms (e.g., complementary structures) 84, 86 coupled to them respectively. The attachment mechanisms 84, 86 are disposed on the external surfaces 88, 90 of the detector 22 and the detector control device 40, respectively. Attachment mechanism 84 includes a slot or pouch 96, while attachment 86 includes a tab 98. The slot or pouch 96 and tab 98 may be located anywhere on the respective surfaces 88, 90. The tab 98 includes a first portion 100 attached to the detector control device 40 and a second portion 102 configured to be inserted with the slot or pouch 96 on the detector 22. The slot or pouch 96 includes an opening 104 for receiving the second portion 102 of the tab 98. Upon inserting tab 98 into the slot or pouch 96, the coupling mechanism 82 enables the coupling of the detector control device 40 to the detector 22 (e.g., with surfaces 88, 90 facing each other) as illustrated in FIG. 5. In certain embodiments, the detector 22 may include the tab 98 and the detector control device 40 may include the slot or pouch 96.

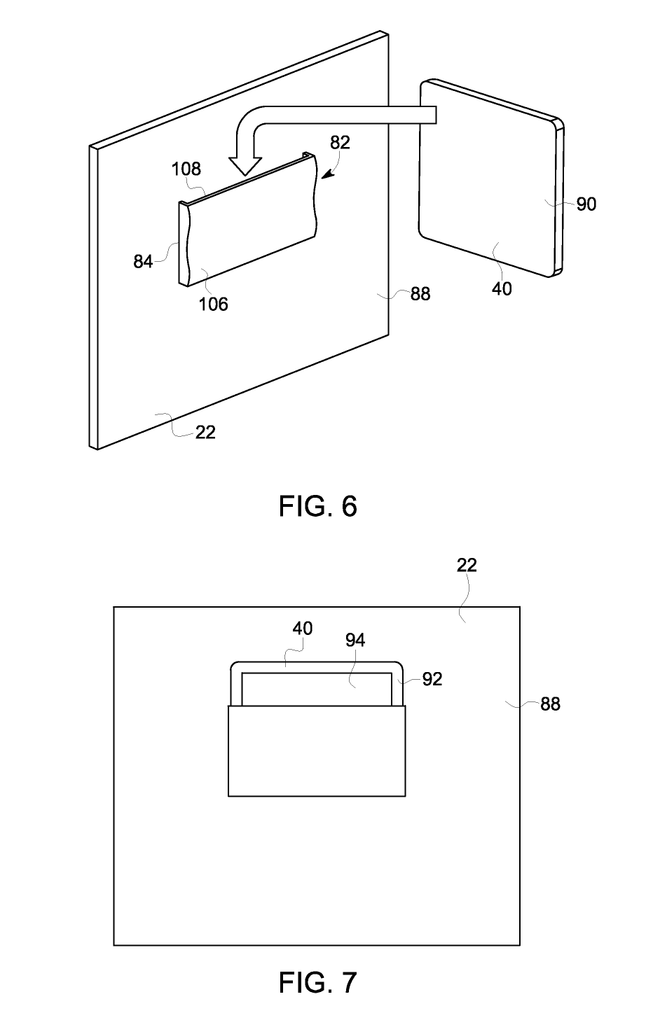

FIG. 6 discloses another embodiment of the device 82 (e.g., coupling mechanism) for coupling the detector 22 and the detector control device 40 together. As above, the coupling mechanism 82 couples or holds together the detector 22 and detector control device 40 together to enable simultaneous transport of both of them. As depicted, the detector 22 includes attachment mechanism 84 coupled to the external surface 88. Attachment mechanism 84 includes a slot or pouch 106 for holding a portion of or the entire detector control device 40 within the slot or pouch 106. The slot or pouch 106 may be located anywhere on surface 88. The slot or pouch 96 includes an opening 108 for receiving the detector control device 40. Upon inserting the detector control device 40 within the slot or pouch 106, the coupling mechanism 82 enables the coupling of the detector control device 40 to the detector 22 (e.g., either with surfaces 88, 90 facing each other) as illustrated in FIG. 7, or potentially with surface 92 of the detector control device 40 facing surface 88 of the detector 22.

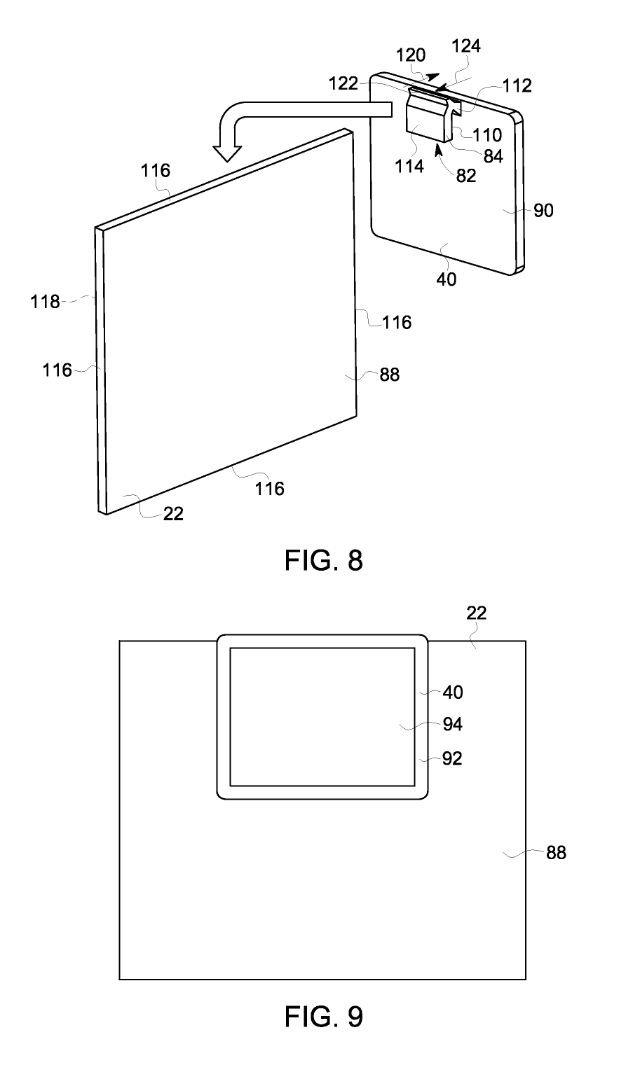

FIG. 8 discloses another embodiment of the device 82 (e.g., coupling mechanism) for coupling the detector 22 and the detector control device 40 together. As above, the coupling mechanism 82 couples or holds together the detector 22 and detector control device 40 together to enable simultaneous transport of both of them. As depicted, the detector control device 40 includes attachment mechanism 84 coupled to the external surface 90. Attachment mechanism 84 includes a clasp 110 for coupling the detector 22 and the detector control device 40 together. The clasp 110 may be located anywhere on surface 90. The clasp 110 includes a first portion 112 attached to the detector control device 40. The clasp 110 also includes a second portion 114 configured to extend over any edge 116 of the detector 22 and to apply pressure to surface 118 of the detector 22 to grasp the detector 22. For example, in certain embodiments, a force may be applied in direction 120 at a top portion 122 of the clasp 110 that causes the portion 114 to extend in direction 124 to enable the clasp to receive the detector 22. Upon releasing the force applied to the top portion 122 of the clasp 110, the portion 114 moves back in direction 120 to grasp the detector 22. The coupling mechanism 82 enables the coupling of the detector control device 40 to the detector 22 as illustrated in FIG. 9. The detector control device 40 may abut either of the surfaces 88, 118 of the detector 22.

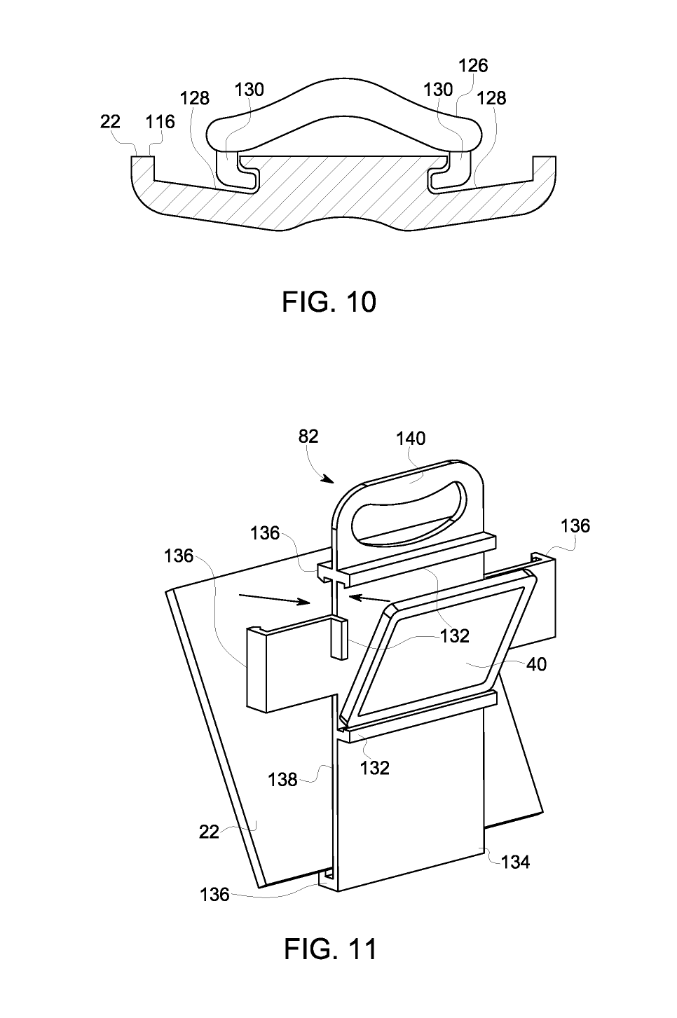

The embodiments disclosed in FIGS. 2-9 may include a removable handle 126 as illustrated in FIG. 10. FIG. 10 depicts a partial cross-sectional view of the detector 22 with the removable handle 126. The handle 126 enables an individual to carry the detector 22 or the detector 22 and detector control device 40. The detector 22 includes grooves or recesses 128 to receive the handle 126. The handle 126 includes projections 130 that fit into the recesses 128 of the detector 22. The recesses 128 may be located along one or more edges 116 of the detector 22. Thus, the handle 126 may be coupled to the detector 22 along any of the edges 116.

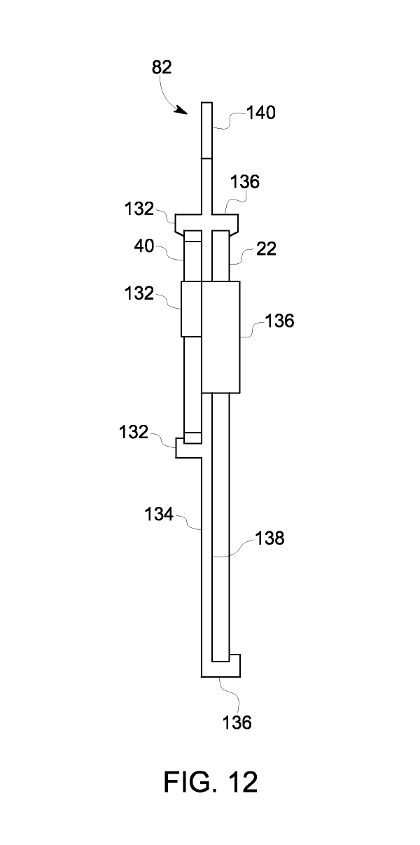

FIG. 11 discloses another embodiment of the device 82 (e.g., coupling mechanism or transport device) for securing and coupling the detector 22 and the detector control device 40 together. The device 82 secures the detector 22 and detector control device 40 to itself to enable simultaneous transport of the detector 22 and the detector control device 40. As depicted, the device 82 (e.g., snap fit caddy) includes a first set of snap features 132 disposed on side 134 of device 82 and a second set of snap features 136 located on an opposite side 138. As illustrated, both sets of snap features 132, 136 include a total of four snap features (e.g., a pair of side snap features, a top snap feature, and a bottom snap feature). In other embodiments, the arrangement and number of snap features may vary. The first set of snap features 132 is spaced apart to receive the detector control device 40 between them. The second set of snap features 136 is spaced apart to receive the detector 22 between them. Upon pressing the detector control device 40 and the detector 22 into their respective sets of snap features 132, 136, the sets of snap features 132, 136 snap about the respective edges of the detector control device 40 and the detector 22 to secure them to the device 82 as illustrated in FIG. 12. The sets of snap features 132, 136 may be made of a pliable material such metal or plastic. The device 82 also includes a handle 140 for the transport (e.g., carrying) of the detector 22 and the detector control device 40 simultaneously.

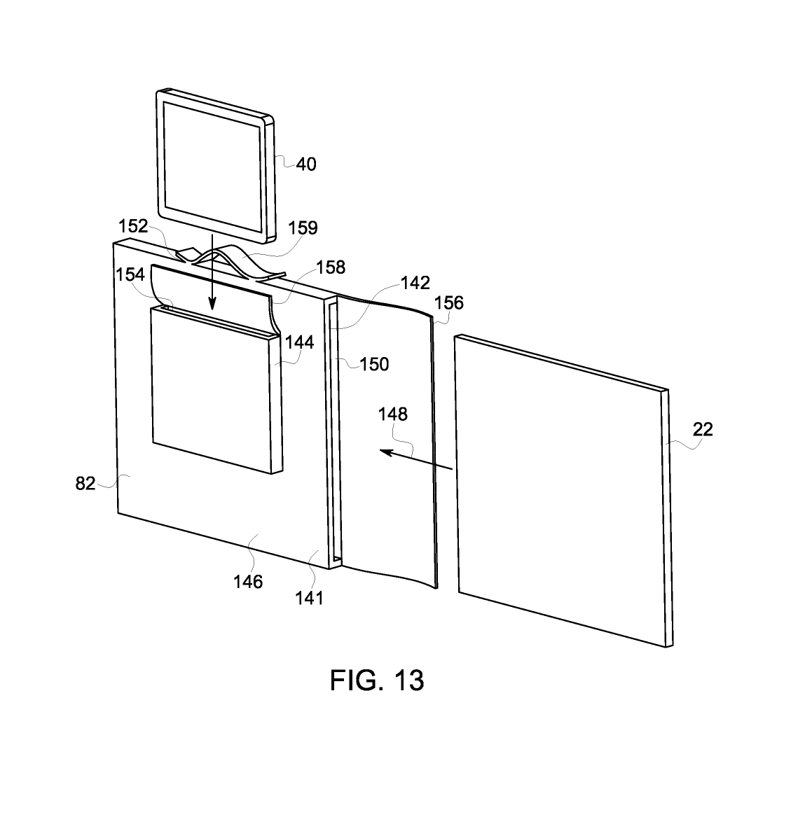

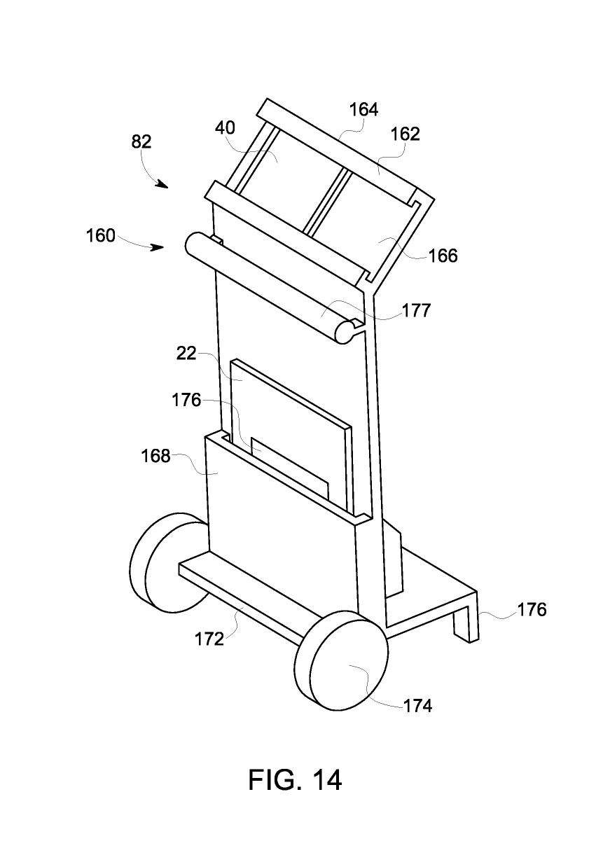

FIG. 13 discloses another embodiment of the device 82 (e.g., coupling mechanism or transport device) for securing or holding the detector 22 and the detector control device 40 together within the device 82. The device 82 secures the detector 22 and detector control device 40 within itself to enable simultaneous transport of the detector 22 and the detector control device 40. As depicted, the device 82 (e.g., folio caddy) includes a main body portion 141 having a pocket 142 for receiving the entire detector 22 within the pocket 142. Another pocket 144 for receiving the entire detector control device 40 is attached to surface 146 of the device 82. As illustrated, the detector 22 is inserted in direction 148 through opening 150 into the pocket 142. The detector control device 40 is inserted in direction 152 through opening 154 into the pocket 144. The pockets 142, 144 each include a cover or flap 156, 158 to fold over respective openings 150, 154 to secure the detector 22 and the detector control device 40 within the pockets 142, 144. The device 82 also includes a handle 159 for the transport (e.g., carrying) of the detector 22 and the detector control device 40 simultaneously.

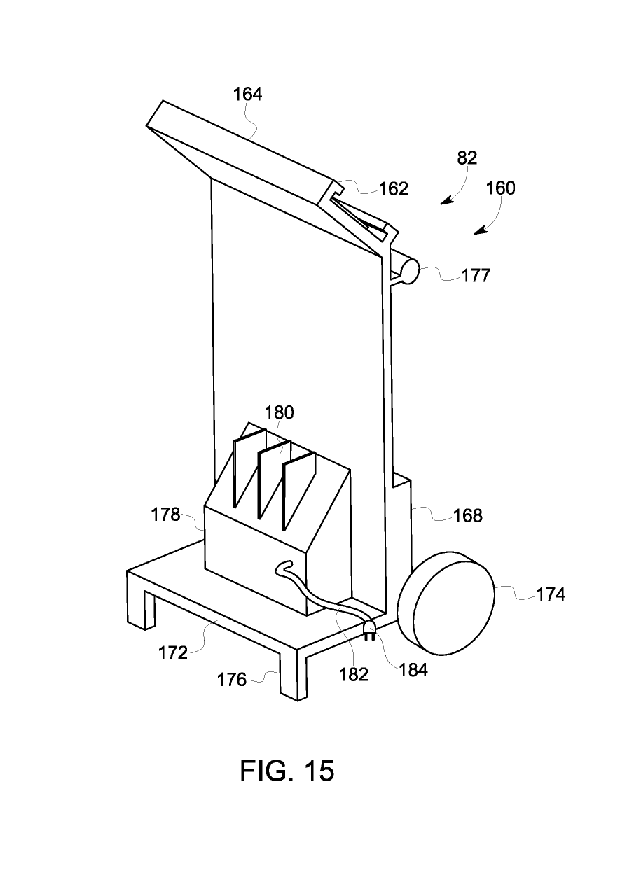

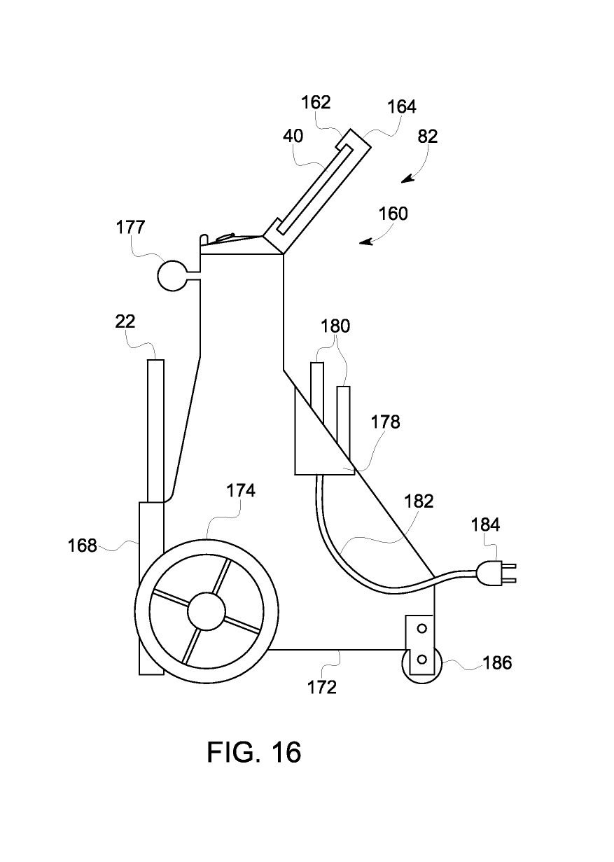

FIGS. 14 and 15 disclose another embodiment of the device 82 (e.g., coupling mechanism or transport device) for securing or holding the detector 22 and the detector control device 40 together on the device 82. The device 82 secures the detector 22 and detector control device 40 on itself to enable simultaneous transport of the detector 22 and the detector control device 40. As depicted, the device 82 includes a cart 160 for holding both the detector 22 and the detector control device 40. The cart 160 includes a holder or retaining feature 162 that holds the detector control device 40 adjacent a top portion 164 (e.g., for using the detector control device 40). In certain embodiments, the holder or retaining feature 162 may be large enough to retain the detector control device 40 but include some additional space 166 for holding other objects (e.g., pens, etc.). The cart 160 also includes a holder 168 for the detector 22, charts 170, and so forth. The holder 168 is located adjacent a base or bottom portion 172 of the cart 160. As depicted, a set of wheels 174 and a set of feet or extensions 176 are coupled to the base 172. The set of wheels 174 enable the movement of the cart 160. The set of extensions 176 keep the cart 160 upright when in a stationary position. The cart 160 further includes a handle 177 for moving (e.g., pulling) the cart 160 from place to place. The cart 160 further includes a charger 178 for holding and charging one or more batteries 180 for the detector 22 and/or detector control device 40. In certain embodiments, the charger 178 may hold and charge the detector 22 or detector control device 40. The charger 178 includes a cord 182 and plug 184. The plug 184 may be inserted into an electrical outlet to obtain power to charge the batteries 180, detector 22, or detector control device 40. In another embodiment, the charger 178 may itself incorporate a larger battery that is used to transfer charge between the charger 178 and the batteries 180.

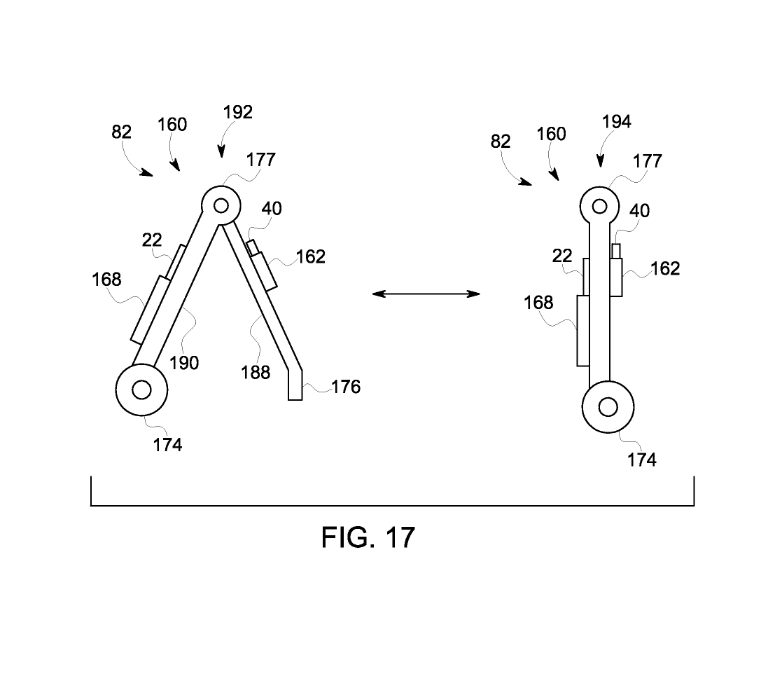

In certain embodiments, the cart 160 may include an additional set of wheels 186, instead of the extensions 176, as illustrated in FIG. 16. The cart 160 in FIG. 16 is otherwise as described in FIG. 15. In certain embodiments, the set of wheels 174 may be larger than the set of wheels 186.

In other embodiments, the cart 160 may be foldable as illustrated in FIG. 17. As depicted, the foldable cart 160 includes the holders 162, 168 for the detector control device 40 and the detector 22, respectively, disposed on opposite sides 188, 190 of the cart 160. Side 188 includes feet 176 disposed near the bottom, while side 190 includes wheels 174 disposed near the bottom. In certain embodiments, the side 188 may include wheels instead of the feet 176. The cart 160 also includes a handle 177 for lifting and/or pulling the cart 160. As depicted, the cart 160 is movable between an unfolded position 192 and a folded position 194. The items on the cart 160 may be transported between places in the folded position 194. Upon reaching the desired destination, the cart 160 may be positioned into the unfolded position 192 so that the items on the cart 160 may be utilized.

Technical effects of the disclosed embodiments include providing the device 82 for securing and holding the detector 22 and detector control device 40 to enable the simultaneous transport of these items together. In particular, the detector 22 and the detector control device 40 may be used to upgrade a conventional analog imaging system. The device 82 enables the transport of the detector 22 and the detector control device 40 from location to location so that these items may be used to retrofit these conventional analog imaging systems for digital imaging. The device 82 simplifies the transport of these items to improve workflow and time efficiency.

This written description uses examples to disclose the present subject matter, including the best mode, and also to enable any person skilled in the art to practice the present approaches, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system comprising:
a portable digital X-ray detector;
a portable detector control device configured to communicate with the digital X-ray detector; and
a coupling mechanism configured to couple the portable digial X-ray detector to the portable detector control device to enable simultaneous transport of the digital X-ray detector and the detector control device, wherein the coupling mechanism does not communicate with any component of an imaging system including the portable digital X-ray detector and the portable detector control device.

2. The system of claim 1, wherein the coupling mechanism comprises magnets disposed internally within both the portable digital X-ray detector and the portable detector control device.

3. The system of claim 2, comprising a removable handle coupled to the portable digital X-ray detector.

4. The system of claim 1, wherein the coupling mechanism comprises hook and loop fasteners disposed externally on both the portable digital X-ray detector and the portable detector control device.

5. The system of claim 4, comprising a removable handle coupled to the portable digital X-ray detector.

6. The system of claim 1, wherein the coupling mechanism comprises a pouch or slot located on an external surface of the digital X-ray detector.

7. The system of claim 6, wherein the pouch or slot is configured to receive at least a portion of the portable detector control device within the pouch or slot.

8. The system of claim 6, wherein the coupling mechanism comprises a tab located on an external surface of the portable detector control device, wherein the pouch or slot is configured to receive a portion of the tab within the pouch or slot to couple the portable detector control device and the digital X-ray detector together.

9. The system of claim 1, wherein coupling mechanism comprises a clasp disposed on an external surface of the portable detector control device and the clasp is configured to extend over an edge of the portable digital X-ray detector to secure the portable digital X-ray detector to the portable detector control device, or the clasp is disposed on an external surface of the portable digital X-ray detector and the clasp is configured to extend over an edge of the portable detector control device to secure the portable detector control device to the portable digital X-ray detector.

10. A system comprising:
a portable digital X-ray detector;
a portable detector control device configured to communicate with the digital X-ray detector; and
a transport device configured to hold both the portable digital X-ray detector and the portable detector control device to enable simultaneous transport of the digital X-ray detector and the detector control device, wherein the transport device does not communicate with any component of an imaging system including the portable digital X-ray detector and the portable detector control device.

11. The system of claim 10, wherein the transport device comprises a first set of snap features configured to receive and secure the portable digital X-ray detector to the transport device upon pressing the portable digital X-ray detector within the first set of snap features, and a second set of snap features configured to receive and secure the portable detector control device to the transport device upon pressing the portable detector control device within the second set of snap features.

12. The system of claim 11, wherein the first set and second set of snap features are disposed on opposite sides of the transport device.

13. The system of claim 11, wherein the transport device comprises a handle.

14. The system of claim 10, wherein the transport device comprises a folio caddy.

15. The system of claim 14, wherein the folio caddy comprises a handle, a first pocket configured to receive the portable digital X-ray detector, a first cover configured to secure the portable digital X-ray detector within the first pocket, a second pocket configured to receive the portable detector control device, and a second cover configured to secure the portable detector control device within the second pocket.

16. The system of claim 10, wherein the transport device comprises a cart.

17. The system of claim 16, wherein the cart comprises a first holder to receive the portable digital X-ray detector and a second holder to receive the portable detector control device.

18. The system of claim 16, wherein the cart comprises a handle.

19. The system of claim 16, wherein the cart comprises wheels to enable the movement of the cart.

20. The system of claim 16, wherein the cart is configured to fold.

21. The system of claim 16, wherein the cart comprises a charger configured to charge the portable digital X-ray detector or one or more batteries for the portable digital X-ray detector.

22. A system comprising:
a device configured to secure both a portable digital X-ray detector and a portable detector control device to the device to enable simultaneous transport of the digital X-ray detector and the detector control device, wherein the device does not communicate with any component of an imaging system including the portable digital X-ray detector and the portable detector control device.

23. The system of claim 22, wherein the device comprises a coupling mechanism configured to couple the portable digial X-ray detector to the portable digital X-ray detector.

24. The system of claim 23, comprising the portable digital X-ray detector and the portable detector control device, wherein the coupling mechanism comprises magnets disposed internally within both the portable digital X-ray detector and the portable digital X-ray detector.

25. The system of claim 23, comprising the portable digital X-ray detector and the portable detector control device, wherein the coupling mechanism comprises a tab located on an external surface of the portable detector control device, wherein the pouch or slot is configured to receive a portion of the tab within the pouch or slot to couple the portable detector control device and the digital X-ray detector together.

26. The system of claim 22, wherein the device comprises a first set of snap features configured to receive and secure the portable digital X-ray detector to the device upon pressing the portable digital X-ray detector within the first set of snap features, and a second set of snap features configured to receive and secure the portable detector control device to the device upon pressing the portable detector control device within the second set of snap features.
